(19) United States
(12) Patent Application Publication
(10) Pub. No.: US 2011/0313995 A1
(43) Pub. Date: Dec. 22, 2011

(54) BROWSER BASED MULTILINGUAL FEDERATED SEARCH

(76) Inventors: Abraham Lederman, Los Alamos, NM (US); Daniel C. Heidebrecht, Santa Fe, NM (US)

(21) Appl. No.: 13/162,252

(22) Filed: Jun. 16, 2011

Related U.S. Application Data
(60) Provisional application No. 61/356,543, filed on Jun. 18, 2010.
(60) Provisional application No. 61/417,454, filed on Nov. 29, 2010.

(51) Int. Cl. G06F 17/30

(52) U.S. Cl. 707/707; 707/E17.108

(57) ABSTRACT

Multilingual federated search of deep web and surface web data stores combines technologies for federated search, surface web searches, for access limited search, and for rapid translation from and to various human languages. A federated search engine accepts a search query and submits it to other search engines. The federated search engine then accepts the various search results, post processes them, and presents them to a user. The surface web is the collection of freely accessible web sites that typically get crawled and indexed by search engines. The deep web is the data that is out there on the internet but having barriers to access such as subscription or technology. Language is also a barrier to access. Multilingual federated search techniques can provide users with search results gleaned from a vast number of sources in a variety of languages.

### CROSS REFERENCE TO RELATED APPLICATIONS

This patent application claims the priority and benefit of U.S. provisional patent application 61/356,543 filed on Jun. 18, 2010 entitled “Multilingual Federated Search Apparatus” and of U.S. Provisional Patent Application No. 61/417,454 filed Nov. 29, 2010 entitled “Browser Based Multilingual Federated Search Services”. Provisional Patent Applications 61/356,543 and 61/417,454 are herein incorporated by reference.

### TECHNICAL FIELD

Embodiments are generally related to search engines, federated search, subscription services, language translation, automated language translation, servers, databases, and web browsers.

### BACKGROUND OF THE INVENTION

Searching for information was one of the first great needs that arose after the widespread deployment and acceptance of the world wide web. Search engines were developed to meet that need. In general, a search engine downloads web pages and indexes them to thereby produce a huge database, called an index, relating search terms to web pages. A user can thereafter submit search terms to the search engine to receive suggestions of which web pages might best meet the user's needs. The search engine can accept other search parameters such as publication windows and exclusion terms that, by their appearance in a document, exclude that document from the search result.

Metasearch engines leverage regular search engines by accepting the user's search terms and then submitting them to a number of different search engines. The metasearch engine then presents an aggregation of the search results returned by the search engines. The meta search engine need never produce its own database of indexed search terms.

Search engines, however, are typically not well suited for guiding users to data that is not on a web page and indexed. The “Deep Web” refers to the vast data resources that can be reached through the internet but do not appear in typical search engine results. In contrast, the “surface web” refers to the data that is normally indexed by normal search engines.

Examples of data sources that are unlikely to contribute to a search engine's results are the “Multiple Listing Service” used by realtors, the Westlaw database used by lawyers, and the various publications' databases used by scientists and engineers. Standard search engines do not index these exemplary databases for two reasons. Firstly, they are often subscription based. Secondly, they are not available in a format that is easily handled by the standard search engines.

Another set of data sources that are unlikely to contribute to a particular user's search results are those data sources in a foreign language that the user does not understand. Foreign language search results can, and do, occasionally appear but they do not contribute anything when a language barrier prevents understanding. Furthermore, search engines tend to return the foreign language references because the foreign web site uses tags, metadata, or foreign language words textually similar to the user's search terms. As such, the references tend to be irrelevant because textual similarity across languages, particularly with metadata, does not reliably indicate similar meanings.

Users typically use web browsers to access search engines. In the recent past, most web browsers have included javascript interpreters and have optionally included java virtual machine plug-ins. These interpreters and plug ins provide the web browser with the capability of running applications and application modules within the browser itself. A more recent advance is HTML 5. Browsers supporting HTML 5 have the capability of running applications as before but with greater abilities with respect to common libraries, user interface elements, and client side storage.

Current technologies have provided average users with an unprecedented ability to find and access knowledge. There are, however, various access barriers due to factors such as language, cost, and technology. Systems and methods for searching and accessing data beyond those access barriers are needed.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is therefore an aspect of the embodiments to serve a web page containing executable code to a web browser that can execute that code. The web page presents a search interface to a user who inputs a search request. The search interface is primarily presented in a first language which is a language the user understands.

It is another aspect of the embodiments that the search request includes search terms. Search engines typically return references to documents or data that include the search terms or words similar to the search terms.

It is yet another aspect of the embodiments that search directives derived from the search request are sent to a variety of search services. The search services can be a combination of free surface web search engines and deep web search services that can be free, subscription based, that require specially formatted search directives, or have other access restrictions. The executable code in the web page can direct the web browser to properly format the search directives, to submit the search directives to the search services, and to collect the directive results that the search services return in response to the search directives. The directive results can be collected and processed to form a search result that is presented to the user by the web browser.

It is a further aspect of certain embodiments that the search interface provides the user with an option to search for documents and data that are in a second language. Search directives can be translated into the second language for submission to search services having indexes in the second language.

It is an additional aspect of some embodiments to present the search result in a language of the user's choosing. The user can choose a language other than the first or second language. As with search directives, search results can be translated into the another language automatically or manually, and on either a free or paid basis.

It is a yet further aspect of certain embodiments that search directives can be sent to subscription based or paid search services or other deep web data sources. In such cases, the user's subscription or payment information can be used to secure access to the deep web data source.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a person using a multilingual federated search system in accordance with aspects of the embodiments;

FIG. 2 illustrates a search interface for a multilingual federated search system in accordance with aspects of the embodiments;

FIG. 3 illustrates a multilingual federated search system generating search directives and assembling search results in accordance with aspects of the embodiments; and

FIG. 4 illustrates a multilingual federated search system using a federated search intermediary in accordance with aspects of the embodiments.

### DETAILED DESCRIPTION

The particular values and configurations discussed in these non-limiting examples can be varied and are cited merely to illustrate at least one embodiment and are not intended to limit the scope thereof.

Multilingual federated search of deep web and surface web data stores combines technologies for federated search, for surface web searches, for access limited search, and for rapid translation from and to various human languages. A federated search engine accepts a search request and submits it to other search engines. The federated search engine then accepts the various search results, processes them, and presents them to a user. The surface web is the collection of freely accessible web sites that typically get crawled and indexed by search engines. The deep web is the data that is out there on the internet but has barriers to access such as subscription or technology. Language is also a barrier to access. Multilingual federated search techniques can provide users with search results gleaned from a vast number of sources in a variety of languages.

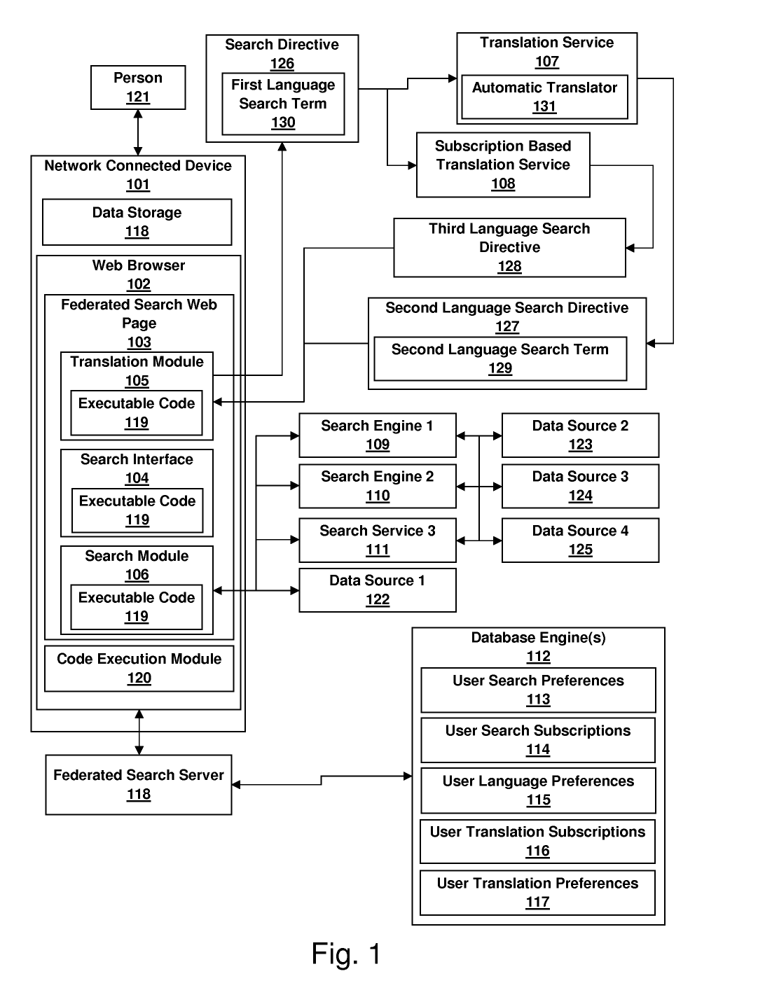

FIG. 1 illustrates a person 121 using a multilingual federated search system in accordance with aspects of the embodiments. The person 121 can use a web browser 102 running on a network connected device 101 to access a federated search server 118 and download a federated search web page 103. The web browser can be compliant with various internet standards and draft standards such as HTML 5. As such, the web browser can execute executable code 119 within the federated search web page 103. Having accessed the federated search web page 103, the person 121 is presented with a search interface 104. The person 121 can enter a search request that is then used to produce various search directives such as search directive 126.

A search directive 126 can contain numerous search terms. In most cases, the search terms are first language search terms 130 because the person uses that language and because the federated search web page 103 is presented to the user in that language. The first language can be specified by user language preferences 115 that can be persistently stored in a data storage area 118 within the network connected device 101 or persistently stored in a database engine 112 that can be accessed by the federated search server or the network connected device 101.

The person 121 may desire to search for information that is in a second language. To accomplish this, the person 121 can specify that searches in the second language be performed. The federated search web page 103 can contain a translation module 105 that either translates the person's search terms directly or that passes the first language search terms 130 to a translation service 107, 108. A subscription based translation service 108 generally requires money in order to perform translations although some such services provide a limited number of translations for free. Stored user translation subscriptions 114 can help the translation module to automatically access subscription services. Some translation services 107 use an automatic translator 131 where a computer running a translation program translates the first language search terms 130 into second language search terms 129. User translation preferences 117 can direct that certain translation services be preferentially used for all or for certain tasks. For example, a free service can be preferred above all others. Another example is that a certain service might excel at English to Mandarin translation while a different service is better at Mandarin to English. The user translation preferences can specify when to use which service to best search in one language or to present results in another.

The result of the translation can be second language search directives 127 or even third language search directives 128. Alternatively, the terms themselves can be translated and returned to the federated search web page 103 for subsequent formatting into search directives.

A search module can send search directives to a variety of search engines 109, 110, 111 and data sources 122. The search engines 109, 110, 111 use the search directives to search data sources 123, 124, 125 and to return directive results to the search module 106. A data source 122, however, can simply returns directive results because it contains indexed data as well as an index whereas most search engines are more index than source data. Some search engines are search services 111 having restrictions to access. Subscription base search services require money whereas others merely require user registration. The web page 103 can access stored user search subscriptions 114 and use them to automatically access a search service 111.

The person can have other persistently stored preferences. User search preferences 113 can specify certain search engines, search services, and data sources that should be used with every search or that should be automatically selected in the web page 103 when it is presented to the person. User language preferences can specify what language the search results are to be presented in. Note that this is slightly different from the browser's language selection. Web browsers can often support a number of different languages and their related character sets. A user can tell the web browser to use Spanish and can tell the federated search system to present all search results in English.

The search module 106 can accept, combine, and format the directive results before passing them to the search interface 104 for presentation to the person 121. The translation module 105 can be used to ensure that all the search results are presented to the user in the language(s) the user desires.

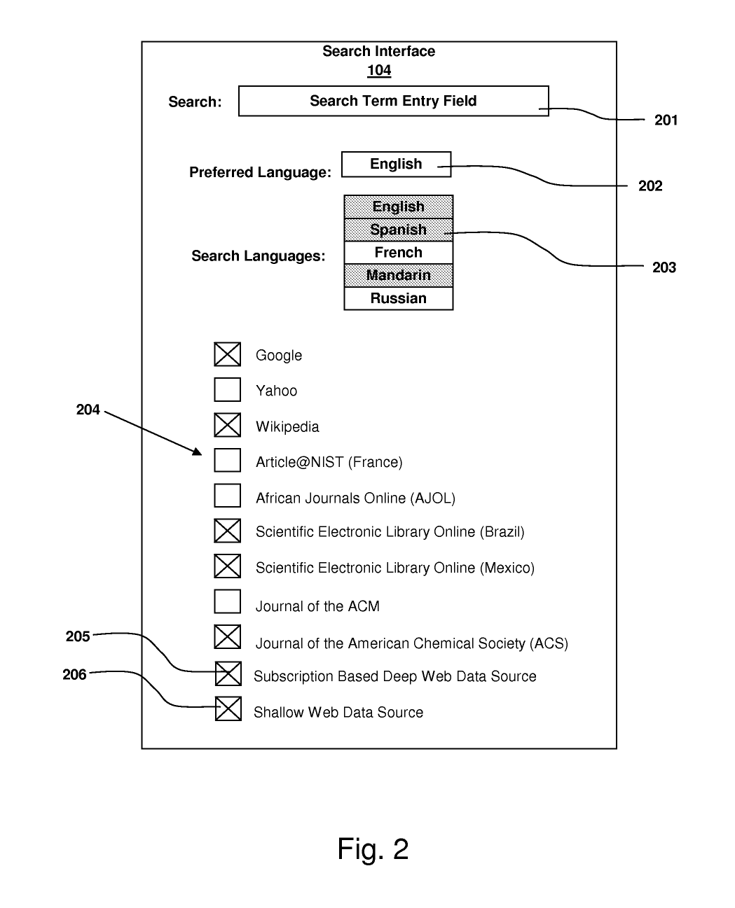

FIG. 2 illustrates a search interface 104 for a multilingual federated search system in accordance with aspects of the embodiments. A user can enter search terms and parameters into the search term entry field 201, select a preferred language 202, and select search languages 203. The user can also select from a variety of search engines, search services, and data stores 204 to choose where the search is to be conducted. Note that all of the selections can be automatically set to the user's preferred choices. The user can alter the selections or simply accept them. As illustrated in FIG. 2, a subscription based deep web data source 205 and a surface web data source 206 are selected. These selections are made only for clarification of some aspects of the embodiments. Some of the named resources are shallow or deep, subscription or free.

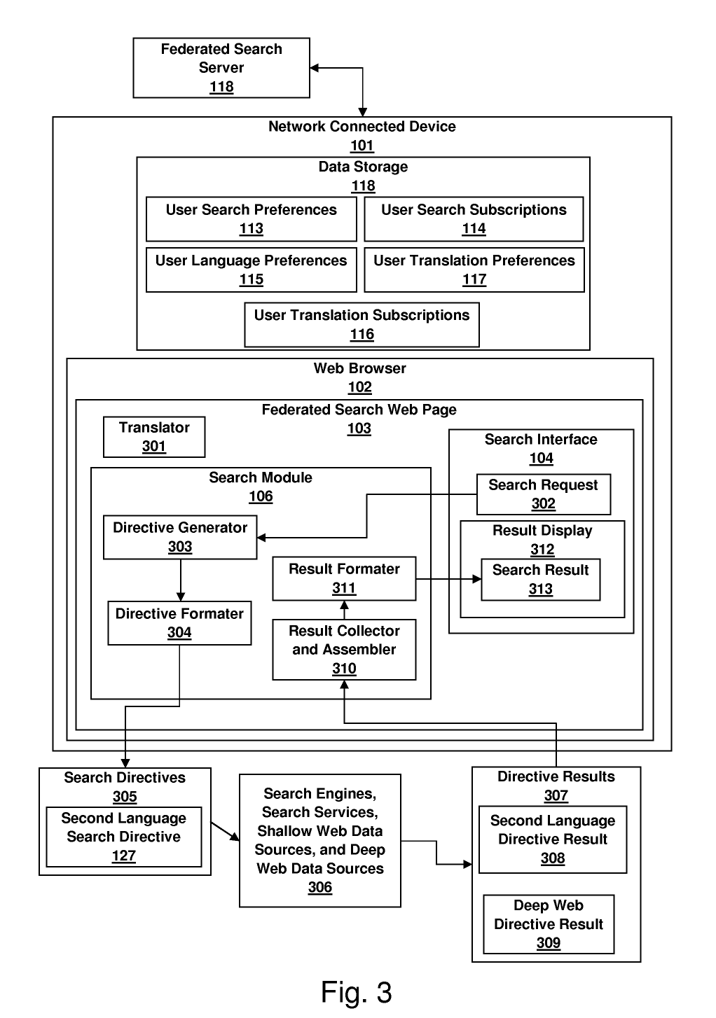

FIG. 3 illustrates a multilingual federated search system generating search directives and assembling search results in accordance with aspects of the embodiments. The various user preferences 113, 114, 115, 116, 117 are illustrated as persistently stored in the data storage 118 of the network connected device 101 and can, in some embodiments, be synchronized with those stored by the database server 112 of FIG. 1.

A person can enter a search request 302 into the search interface 104. A directive generator 303 and directive formatter 304 can use the search request 302 to generate search directives 305 that are transmitted to search engines, search services, shallow web data sources, and deep web data sources 306 that return directive results 307. The search directives 305 can include second language search directives 127. The directive results 307 can include second language directive results 308 and deep web directive results 309.

A translator 301 executing as a module in the federated search web page 103 can translate search terms from the first language into the second language. Similarly, the translator 301 can translate the directive results 307, including the second language directive results 308, into the user's preferred language. The translator 301 can be an executable code module that uses translation data persistently stored in data storage 118 because recent web browser standards provide for browsers to persistently store data in structures more complicated than the cookies of before.

The directive results 307 are returned to the web browser 102 where they are collected and assembled 310, formatted 311 into a search result 313 and presented to the person in a result display 312.

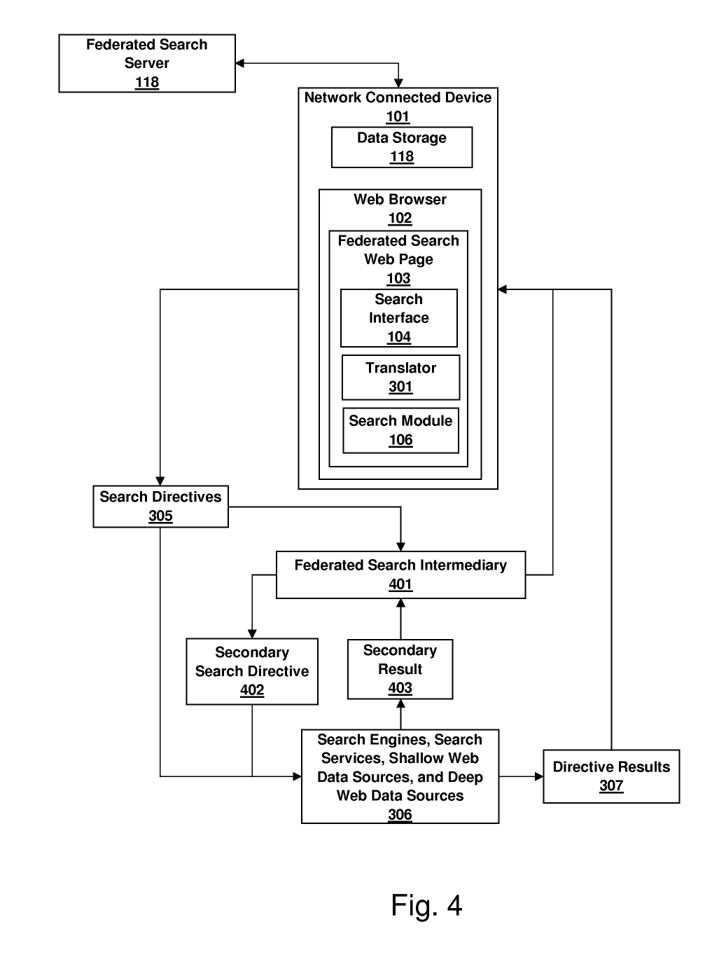

FIG. 4 illustrates a multilingual federated search system using a federated search intermediary 401 in accordance with aspects of the embodiments. Search directives 305 can be passed to a federated search intermediary 401 as easily as they can be passed to any other search engine, search service, or data source. The intermediary 401 can create further directives that are then passed to the various network connected search engines, search services, and data sources 306 that can be reached on through a communications network. The secondary search directives 402 are processed to produce secondary results 403 that the federated search intermediary 401 receives, optionally assembles into a single result, and passes back to the web browser 102 for treatment as any other directive result 307.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system comprising:
a web page comprising executable code;
a federated search server that provides the web page to a web browser running on a network connected device wherein the web browser executes the executable code to present a search interface to a person, wherein the search interface comprises information displayed in a first language, wherein the search interface comprises an option to search in a second language, and wherein the web browser accepts the search request from the person;
a plurality of search directives wherein the browser executes the executable code to thereby generate the plurality of search directives and transmit the plurality of search directives to a plurality of search services, and wherein the search directives comprise a second language search directive specifying searching in the second language;
a plurality of directive results wherein the browser executes the executable code to accept a plurality of directive results and to format the directive results into a search result; and
a result display that presents the search result to the person.

2. The system of claim 1 wherein the second language search directive comprises at least one second language search term that is in the second language and wherein the web browser submits at least one first language search term to a translator and wherein the translator returns the at least one second language search term.

3. The system of claim 2 wherein the translator is an automated translator.

4. The system of claim 2 wherein the translator is a subscription based translation service.

5. The system of claim 4 further comprising a database wherein the web browser accesses the database to obtain translation subscription information and uses the translation subscription information to access the subscription based translation service.

6. The system of claim 1 further comprising user language preferences that provide guidance toward formatting the directive results into a search result.

7. The system of claim 1 wherein the person prefers to obtain the search result in a specific language and wherein a translator translates at least one of the directive results into the specific language.

8. The system of claim 8 wherein the specific language is not the first language.

9. The system of claim 1 wherein the directive specifying searching in the second language is transmitted to a search engine directed toward speakers of the second language.

10. A system comprising:
a web page comprising executable code;
a federated search server that provides the web page to a web browser running on a network connected device wherein the web browser executes the executable code to present a search interface to a person, wherein the search interface comprises an option to include a deep web data source in a search request, and wherein the web browser accepts the search request from the person;
a plurality of search directives wherein the browser executes the executable code to thereby generate the plurality of search directives and transmit the plurality of search directives to a plurality of search services, and wherein one of the search directives is transmitted to the deep web data source;
a plurality of directive results wherein the browser executes the executable code to accept a plurality of directive results and to format the directive results into a search result; and
a result display that presents the search result to the person.

11. The system of claim 10 further comprising a directive formatter wherein at least one of the search services accepts differently formatted search directives and the directive formatter ensures that each search service receives acceptably formatted search directives.

12. The system of claim 10 wherein the deep web data source is a subscription based data source.

13. The system of claim 12 further comprising a database wherein the web browser accesses the database to obtain data source subscription information and uses the data source subscription information to access the deep web data source.

14. A system comprising:
a web page comprising executable code;
a federated search server that provides the web page to a web browser running on a network connected device wherein the web browser executes the executable code to present a search interface to a person, and wherein the web browser accepts a search request from the person;
a plurality of search directives wherein the browser executes the executable code to thereby generate the plurality of search directives and transmits the plurality of search requests to a plurality of search services;
a plurality of directive results wherein the browser executes the executable code to accept a plurality of directive results and to format the directive results into a search result; and
a result display that presents the search result to the person.

15. The system of claim 14 further comprising a database storing data comprising a user search preference that specifies the destination of at least one of the search directives.

16. The system of claim 14 further comprising a federated search intermediary wherein the search interface comprises an option to include a plurality of deep web data sources in the search request, wherein one of the search directives is transmitted to the federated search intermediary, wherein the federated search intermediary transmits a secondary search directive to at least one of the deep web data sources, accepts a secondary result from the at least one of the deep web data sources, and returns intermediary search results to the web browser.

17. The system of claim 14 further comprising a federated search intermediary wherein one of the search directives is transmitted to the federated search intermediary, wherein the federated search intermediary transmits a secondary search directive to at least one secondary search service, accepts a secondary result from the at least one secondary search service, and returns intermediary search results to the web browser.

18. The system of claim 14 further comprising:
a directive formatter wherein at least one of the search services accepts differently formatted search directives and the directive formatter ensures that each search service receives acceptably formatted search directives; and
a database wherein the web browser accesses the database to obtain data source subscription information and uses the data source subscription information to access a subscription based deep web data source, wherein the search interface comprises an option to include a deep web data source in a search request, and wherein one of the search directives is transmitted to the deep web data source.

19. The system of claim 18 further comprising:
an option to search in a second language wherein the search interface further comprises the option to search in a second language and wherein the search interface comprises information displayed in a first language;
a database wherein the web browser accesses the database to obtain translation subscription information and uses the translation subscription information to access an automated subscription based translation service;
a second language search directive specifying searching in the second language wherein the search directives comprise the second language search directive, wherein the second language search directive comprises at least one second language search term that is in the second language, wherein the second language search directive is transmitted to a search engine directed toward speakers of the second language, and wherein the web browser submits at least one first language search term to a translator and wherein the translator returns the at least one second language search term; and
user language preferences that provide guidance toward formatting the directive results into a search result, wherein the person prefers to obtain the search result in a specific language, wherein the translator translates at least one of the directive results into the specific language, and wherein the specific language is not the first language;

20. The system of claim 14 further comprising:
an option to search in a second language wherein the search interface further comprises the option to search in a second language and wherein the search interface comprises information displayed in a first language;
a database wherein the web browser accesses the database to obtain translation subscription information and uses the translation subscription information to access an automated subscription based translation service;
a second language search directive specifying searching in the second language wherein the search directives comprise the second language search directive, wherein the second language search directive comprises at least one second language search term that is in the second language, wherein the second language search directive is transmitted to a search engine directed toward speakers of the second language, and wherein the web browser submits at least one first language search term to a translator and wherein the translator returns the at least one second language search term; and
user language preferences that provide guidance toward formatting the directive results into a search result, wherein the person prefers to obtain the search result in a specific language, wherein the translator translates at least one of the directive results into the specific language, and wherein the specific language is not the first language.
